(19) United States
(12) Patent Application Publication
(10) Pub. No.: US 2011/0016237 A1
(43) Pub. Date: Jan. 20, 2011

(54) Scales and method for its configuration

(75) Inventors: Karl Markus Rainer Amman, Albstadt (DE); Robert Winkler, Bisingen (DE); Ralf Grespan, Balingen (DE); Steffen Michael Rohm, Sigmaringen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bizerba GmbH & Co. KG, Balingen (DE)

(21) Appl. No.: 12/867,469

(22) PCT Filed: Feb. 16, 2009
(86) PCT No.: PCT/EP09/01068

§ 371 Date: Oct. 6, 2010

(30) Foreign Application Priority Data
Feb. 14, 2008 (DE) 10 2008 009 115.4

(51) Int. Cl. G06F 3/00

(52) U.S. Cl. 710/10

(57) ABSTRACT

The invention relates to a method for configuring the interaction between a balance and input and output devices communicating therewith, comprising a user module for controlling the output devices and interrogating input devices, wherein the interaction functionalities of the balance are defined by the user module. The profile module is automatically coupled to the user module depending data received by the user module. The invention further relates to a balance wherein the above method is used.

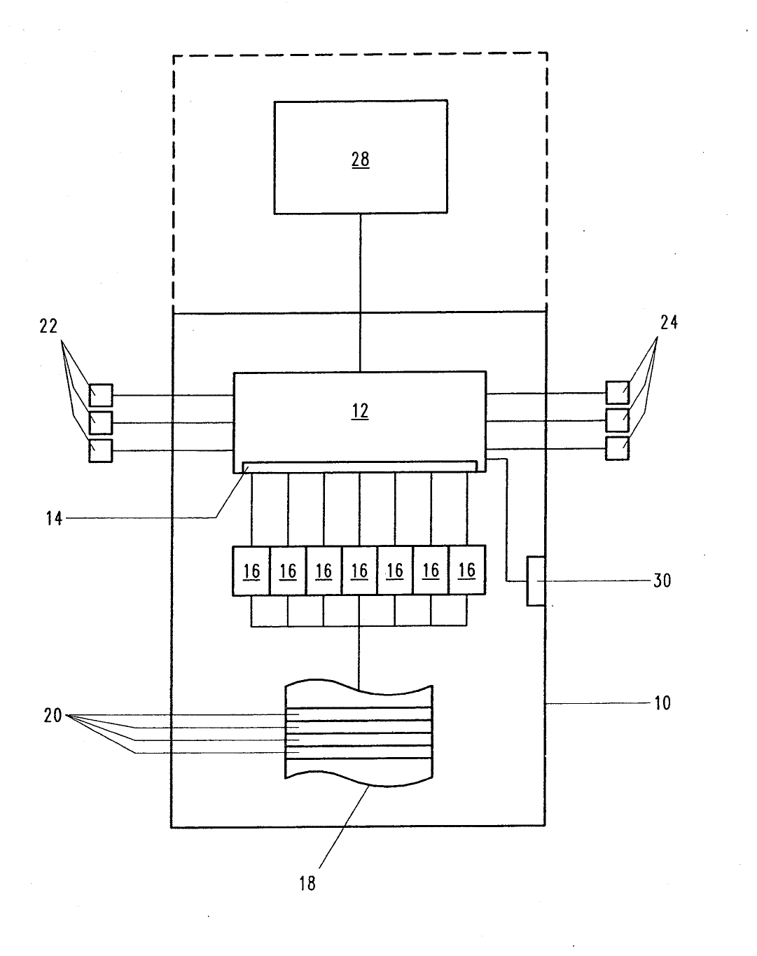

The invention relates to a method for the configuration of the interaction between scales and input/output devices communicating therewith as well as to scales in which such a method is used.

It is known to equip scales with additional functions which go far beyond the pure weighing procedure. Such additional functions are, for example, a display of advertising to customers, an automatic user recognition, an automatic product recognition and the like. It is furthermore known to offer different users of the scales different functions via correspondingly desired interfaces.

To be able to implement such scales, it is necessary to control a user interface of the scales in dependence on a respective currently used function in different manners. In a large number of applications, this is implemented by different layouts of a monitor coupled to the scales, wherein the layouts are here adapted to the respective current function. There are, however, also applications in which the user interface is not implemented only by a monitor, but additionally also by a voice output or a printer, wherein corresponding function adaptations are also to be carried out here.

The fact is disadvantageous in scales of the described type that their operation is often complicated and time-intensive in design. In particular operation by customers or untrained personnel is frequently problematic.

DE 100 39 668 A1 describes scales which is designed to communicate with input and/or output devices, wherein an interaction logic is fixedly preset for the communication of the scales with the input and/or output devices, and wherein user-dependent parameter sets are provided which are different from one another. DE 10 2006 011 791 A1 describes a corresponding scales. The parameters are fixed values which can be varied within a preset range such as font size, font, background color or language of a screen output.

It is an object of the invention to provide a method of the initially named kind as well as scales in which such a method is used which enable a simpler and faster operation. It should in particular be possible to change or adapt the interaction options with the scales, e.g. a user interface of the scales, also after its delivery, with a small effort.

This object is satisfied in accordance with the invention by a method for the configuration of the interaction between scales and input/output devices communicating therewith,

having a user module for the control of output devices and the interrogating of input devices, with the interaction functions of the scales being defined by the user module;
having a plurality of profile modules for the specification of the interaction functions preset by the user module,
wherein the profile modules are automatically coupled to the user module in dependence on data received by the user module.

The named object is furthermore satisfied by scales having internal and/or external input/output devices,

having a user module for the control of the output devices and the interrogating of the input devices, with the interaction functions of the scales being defined by the user module;
having a plurality of profile modules for the specification of the interaction functions preset by the user module; and
having a coupling unit for the automatic coupling of at least one of the profile modules to the user module in dependence on data received by the user module or by the coupling module.

The term interaction function, for example, includes functions of the scales with respect to an interaction between a user and the scales, preferably input functions, output functions and additional functions such as promotion functions, that is e.g. cross-merchandising.

In accordance with the invention, a modular construction is therefore used in which a division into at least one user module and a plurality of profile modules is present. The user module which can no longer be subsequently changed by a user as a rule only fixes the interaction functions of the scales and has to be coupled, to be able to take over a complete control of the scales, to a profile module which specifies the interaction function preset by the user module in more detail. The profile modules are in this respect preferably subsequently still changeable by a user and thus adaptable to the respective given individual needs.

The profile modules define an interaction profile with which inter alia a user interface, the data input and the data output of the scales are configured.

In previous solutions, a server for an input constantly had constantly to interrogate the different data inputs of the scales. In the invention, the user module takes over this interrogation and transforms the data on the one hand into a form simple to read for a user and, on the other hand, into a data sequence simple to read for a server.

The following mode of operation can be provided, for example. When a transaction routine expects an article recognition and when an input via a scanner or a keyboard is configured in the profile module, the user module will transform the data received from the scanner or keyboard into a data sequence for the server and then transfer it to the server. A new data sequence then transmitted as a response by the server can then trigger a further interaction such as a further article recognition with a defective article in dependence on the data sequence and on the configuration stored in the profile module or it continues the transaction routine, e.g. an article registration or a conclusion of a sale.

The profile modules can thus define different functions of the scales, with a separate profile module being provided, for example, for each of the functions or for each of the transaction routines “sell-out”, “inventory”, “maintenance/service”, etc.

The user module can thus, as required, in dependence on the respective coupled profile module, e.g. now control a user interface for weighing, another time an information interface for a customer or in yet another application a service interface for the servicing of the scales by a technician.

A substantial advantage of the invention can be seen in the fact that the profile modules are automatically coupled to the user module in dependence on the data received by the user module. If the scales is, for example, equipped with a user recognition module and if it recognizes a user by this user recognition module who may act as a store manager, the user module receives data characterizing the role of the store manager, whereupon the user module is automatically coupled to a store manager-specific profile module. Due to this coupling, the interaction for the role of the store manager can then, for example, be provided to the store manager, within the framework of which he may change article types, price data or layouts of screen displays.

If, for example, a user recognition module recognizes a specific salesperson, a coupling with a sales person-specific profile module can take place in a corresponding manner. Provision is made in this respect that the associated profile module or interaction profile is selected and coupled to the user module based on the data sent. Such a sales person-specific profile module or interaction profile can have the effect, for example, that all the displays for the salesperson take place in a language which corresponds to his nationality.

In accordance with the invention, the scales can thus adjust automatically and very fast to the respective desired application. In many cases, this can take place fully automatically without a user having to make any input at the scales since the coupling between the user module and the respective matching profile module takes place in dependence on the data sets or data sequences received. The data can in this respect, for example, be transmitted by connected input devices such as a user recognition module to the user module, but can also originate from other sources which will be explained in the following.

In particular systems of rules for the processing of parameters are provided by the profile modules. The limits for the system of rules are preset by base functions which the user module provides. The profile modules are in particular program modules, for example XML scripts.

Rules for the data processing can be set up by the profile modules. Conditions can in particular be defined in accordance with which a processing of a specific parameter takes place. It can, for example, be laid down whether or how a specific data format should be reacted to, e.g. whether an MP3 file is output in audio form or a visualization is started.

The interaction functions preset by the user module are in particular specified by the presetting of rules and/or conditions for the processing of data, with the presetting of the rules and/or conditions preferably taking place as an executable script.

It is preferred when the profile modules can be extended and/or modified by a user. In this manner, an adaptation of the functions of the scales can be carried out by the respective user himself after the delivery of the scales without a service technician having to be engaged for this purpose.

In particular the interaction of the scales is laid down in the profile modules. Which input/output devices are to be activated or deactivated can therefore be defined therein. For example, a user can always thus himself determine at that time with which input/output devices the scales should communicate. If therefore, for example, a new input device such as a voice recognition module should be connected, it is not necessary to request a service technician for this purpose since it is rather sufficient if the store manager modifies a profile module such that it is suitable for the control of a voice recognition module. Alternatively, the voice recognition module could also simply be connected to the scales, whereupon it transmits characteristic data to the user module which then automatically carries out a coupling to a profile module which is already present in the scales and is suited to control a voice recognition module.

It is particularly preferred if the profile modules include at least one reference, in particular a pointer or a mapping via table references to one or more interaction files which defines a specific design which includes graphic elements and/or text elements or activates a voice output matching an article and defines the properties of the voice output, that is e.g. whether the voice output takes place with a male or female voice or in a loud or soft voice. This means that the interaction data actually being displayed are not included in the profile module itself. These data rather exist in the form of a separate file and only a pointer to these data is included in the profile module itself.

A profile module can also include a plurality of pointers to different interaction files which are activated on the operation of the user module coupled to the profile module in dependence on the respective operating state. It is thus possible, for example, to switch between different display modes in an individual application in which a specific profile module remains coupled to the user module.

A profile module preferably activates a plurality of interaction files simultaneously in dependence on the respective operating state. For example, a screen output can be output in the language of the salesperson on a salesperson display and a screen output can be output in the language of the customer on a customer display with the same profile module, with the two languages being different from one another. Further languages not yet supported can be added in a simple manner by installation of a further interaction file.

In accordance with an embodiment of the language, all basic interaction functions are fixed by the user module. The profile modules serve for the specification of the interaction functions which are preset by the user module and which are automatically coupled. The interaction files serve for the storage of parameters.

It is particularly preferred if the named interaction files can be modified by means of an interaction designer. In this way, changes to the screen layout can be carried out in a graphical and text aspect using a screen designer depending on the needs of the customers, of the market in which the scales is installed or on the operating personnel. It must be mentioned only by way of example that the language of the information displayed in text form can be changed, that input fields of a touch screen can be moved, modified, added or deleted, that image information can be changed or that a voice of a loudspeaker output can be changed.

An interaction designer is a tool with which the interaction, in particular the multimedia interaction, of users with the scales can be fixed. The manner of the input and/or of the output of data as also their presentation are in particular fixed. Multimedia interaction means that optical and acoustic inputs and/or outputs of data are provided, in addition to the medium of writing, for the interaction between the user and the scales.

The interaction profiles laid down by the interaction designer are stored in the interaction files. An interaction file can include parameters, in particular operating parameters of input devices and/or of output devices, that is their parameterization. The interaction fields can, however, also include, in addition to operating parameters, for example, resources such as the language or the font. In addition, the interaction file can include a layout of a user interface and/or of a voice output and/or an image output or video output.

A screen designer can e.g. be a component of an interaction design, wherein the screen designer can fix the optical presentation of a user interface.

It is generally possible to change the function of the scales (e.g. operating logic or operator rights) with unchanging parameters by a change of the profile modules and simultaneous maintaining of the interaction file(s).

It is in particular advantageous when the user module also receives data of services which are delivered by a server. Such a sensor can, for example, provide the service of an image recognition so that complex image recognition logarithms do not have to be done by an input device connected to the scales and also not by the user module. It is rather the case that the data received from a camera, for example, are transferred by a user module coupled to a respective profile module to a server for the image evaluation, said server then taking over the image processing and delivering back the code of a recognized user to the user module as the result, for example. Such data can also then effect the coupling of the user module to a respective matching profile module so that it can generally be stated that, in accordance with the invention, the coupling of profile modules to the user module can take place in dependence on any desired data received by the user module, with such data in particular being delivered by an input device or by a server. The server can naturally take over any desired further tasks such as a receipt management, data management for an inventory, etc.

At least one of the following components can be used as the input device in accordance with the invention:

User recognition module (purchaser/salesperson), product recognition module, language recognition module, card reader, e-cash reader, scanner, computer mouse, keyboard, key switch, retinal scanner, camera, RF identification module, fingerprint sensor.

For example, a customer in a store can thus be recognized via a user recognition module and his attention can be drawn via display devices coupled to the scales to special offers which match his previous purchases. The profile module suitable for this purpose is coupled to the user module on the basis of the user recognition carried out and now, for example, accesses a service of the server which has information present on the previous purchases of the respective customer and can transfer it to the user module accordingly.

In this respect, the previous purchases of the customer do not necessarily have to be processed via one and the same scales. It is rather possible to connect a plurality of scales in accordance with the invention to a network when the plurality of scales, which is preferred, are equipped with at least one interface for the communication with further scales and/or with a server. If such a network has a server, its services can be provided to all scales so that, for example, all purchases of a customer made via different scales can be stored in a database managed by the server.

In a network of the described kind, which can be made with or without servers, it is furthermore preferred if each of the plurality of scales can access the functions of the other scales so that comparatively simple scales can also provide the functions of more complex scales. The total network can be implemented more inexpensively in this manner since it is enough to provide specific functions only at individual scales.

In scales in accordance with the invention, one of the following components can be used as the output device:

Display device, in particular a monitor, preferably a plurality of monitors, a cash register drawer, a packing machine, a display, a printer, a voice output for user guidance or audio playback of audio files.

In accordance with the invention, a specific salesperson can therefore, for example, register at the scales by means of an RF identification module, whereupon the profile module matched to him is coupled to the user module. It is stored in this profile module that the salesperson is of Greek origin so that all displays on a salesperson monitor take place in the Greek language. If the scales now recognizes a customer via a user recognition module for whom it is stored in the scales or in the server that he speaks the Spanish language, a pointer to an interaction file which is held in the Spanish language can be activated in the active profile module. All the displays on a customer monitor can then take place in the Spanish language in accordance with this interaction file. To carry out the corresponding settings at the scales, it is sufficient in accordance with the invention if the respective salesperson and the respective customer are recognized since all accordingly required settings are then carried out fully automatically.

Further preferred embodiments of the invention are explained in the dependent claims.

The invention will be explained in the following by way of example with reference to the drawing.

The only FIGURE shows scales 10 in which a user module 12 is arranged in a schematic representation. A coupling unit 14 via which the user module 12 can be selectively coupled to a profile module 16 is a component of the user module 12. In the example case shown, a total of seven profile modules 16 are present which are different from one another, which are wired to the coupling unit 14 and which are accordingly couplable to the user module 12 in dependence on the respective application case.

The profile modules 16 are connected to a memory 18 in which a plurality of interaction files 20 is stored. As already explained, the profile modules 16 each include at least one pointer to one of the interaction files 20 so that the interaction files 20 define the design of a display or of a monitor which is activated by the user module 12 coupled to a profile module 16.

The user module 12 is coupled to three input devices 22 and three output devices 24. As already explained, these input/output devices 22, 24 are activated, deactivated and parameterized via the respective selected profile module 16.

Finally, the user module 12 is also connected to a server 28 which provides the scales 10 with higher ranking services of the already explained kind and can also deliver data to the scales 10 which then effects the automatic coupling of the user module 2 to a specific profile module 16. The server 28 can in this respect represent an external component with respect to the scales 10. Alternatively, the server 28 can, however, also be a component of the scales 10, which is indicated by the course of the dashed line in the FIGURE.

Scales 10 can communicate with further scales or with an external server or also with a bus system, to which any desired further devices can be connected, via an interface 30 connected to the user module 12.

Alternatively to the hardwired hardware embodiment shown in the FIGURE, the principle in accordance with the invention can also be implemented as software on a client-server architecture known from the prior art. In this case, the user module 12 represents a client whose function is specified in more detail by profile files, with these profile files corresponding in their functions to the profile modules 16 in accordance with the FIGURE. These profile files are preferably executed as XML files or csv files in this case. The user module formed as a client furthermore also accesses interaction files 20 such as are shown in the FIGURE.

The server 28 shown in the FIGURE can be made by way of software as a server module in a client-server architecture.

### REFERENCE NUMERAL LIST

10 scales
12 user module
14 coupling unit
16 profile module
18 memory
20 interaction files
22 input devices
24 output devices
28 server
30 interface

1-16. (canceled)

17. A method for the configuration of the interaction between scales (10) and input/output devices (22, 24) communicating therewith,
having a user module (12) for the control of output devices (24) and the interrogating of input devices (22), with the interaction functions of the scales (10) being defined by the user module (12); and
having a plurality of profile modules (16) for the specification of the interaction functions preset by the user module (12),
wherein the profile modules (16) are automatically coupled to the user module (12) in dependence on data received by the user module (12).

18. A method in accordance with claim 17, characterized in that the interaction functions preset by the user module (12) are specified by the presetting of rules and/or conditions for the processing of data, with the presetting of the rules and/or conditions taking place as an executable script.

19. A method in accordance with claim 17, characterized in that the profile modules (16) can be expanded and/or modified by a user and/or the profile modules (16) define which input/output devices (22, 24) are to be activated or are to be deactivated.

20. A method in accordance with claim 17, characterized in that the profile modules (16) include at least one reference to an interaction file (20) which defines a voice output and/or an audio output and/or a specific design which includes graphical elements and/or text elements.

21. A method in accordance with claim 20, characterized in that at least one profile module (16) includes a plurality of pointers to interaction files (20) which are activated in dependence on the respective operating state on the operation of the user module (12) coupled to the profile module (16).

22. A method in accordance with claim 20, characterized in that a profile module (16) activates a plurality of interaction files simultaneously in dependence on the respective operating state.

23. A method in accordance with claim 20, characterized in that the interaction files (16) define operating parameters for the input/output devices (22, 24) and/or can be modified by means of an interaction designer.

24. A method in accordance with claim 17, characterized in that the user module (12) also receives data from services which are delivered by a server (28).

25. A method in accordance with claim 17, characterized in that at least one of the following components is used as an input device (12):
user recognition module (buyer/salesperson), product recognition module, language recognition module, card reader, e-cash reader, scanner, computer mouse, keyboard, key switch, retinal scanner, camera, RF identification module, fingerprint sensor; and/or
in that at least one of the following components is used as the output device (24):
display device, in particular monitor, preferably a plurality of monitors, cash register drawer, packing machine, display, printer, voice output for user guidance or audio playback of audio files.

26. A method in accordance with claim 17, characterized in that the profile modules (16) are made as XML files or csv files.

27. A method in accordance with claim 17, characterized in that the user module (12) is made as a client in a client-server architecture.

28. A method in accordance with claim 17, characterized in that the user module (12) and the profile modules (16) are made as separate hardware units.

29. Scales (10) having internal and/or external input/output devices (22, 24)
having a user module (12) for the control of the output devices (24) and the interrogating of the input devices (22), with the interaction functions of the scales (10) being defined by the user module (12);
having a plurality of profile modules (16) for the specification of the interaction functions preset by the user module (12); and
having a coupling unit (14) for the automatic coupling of at least one of the profile modules (16) to the user module (12) in dependence on data received by the user module (12) or by the coupling module (14).

30. Scales in accordance with claim 29, characterized in that the coupling unit (14) is a component of the user module (12).

31. Scales in accordance with claim 29, characterized in that the scales (10) has at least one interface (30) for the communication with further scales (10) and/or with a server.

32. Scales in accordance with claim 31, characterized in that a plurality of scales (10) are connected via their interfaces (30) to a network, with the functions of the other scales (10) being provided to each of these scales (10), with the network preferably having a server whose services are available to all the scales (10).
